(19) United States
(12) Patent Application Publication
(10) Pub. No.: US 2025/0308799 A1
(43) Pub. Date: Oct. 2, 2025

(54) MULTILAYER CERAMIC CAPACITOR

(71) Applicant: Murata Manufacturing Co., Ltd., Nagaokakyo-shi (JP)

(72) Inventors: Kouta TANAKA, Nagaokakyo-shi (JP); Hiroaki SUGITA, Nagaokakyo-shi (JP); Satoshi MIYAUCHI, Nagaokakyo-shi (JP)

(21) Appl. No.: 19/046,733

(22) Filed: Feb. 6, 2025

(30) Foreign Application Priority Data
Mar. 27, 2024 (JP) 2024-052257

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer ceramic capacitor includes an inner layer portion including inner dielectric layers and internal electrode layers laminated alternately in a lamination direction. Each of the internal electrode layers includes an end portion in a width direction including a region A with a low continuity of each of the internal electrode layers at the end portion. The region A has a line coverage lower than that in a middle portion in the width direction of each of the internal electrode layers.

### CROSS REFERENCE TO RELATED APPLICATION

This application is based on and claims the benefit of priority from Japanese patent Application No. 2024-052257, filed on Mar. 27, 2024, the entire contents of which are incorporated herein by reference.

### BACKGROUND OF THE INVENTION

### 1. Field of the Invention

The present invention relates to multilayer ceramic capacitors.

### 2. Description of the Related Art

In the prior art, multilayer ceramic capacitors each include a multilayer body in which dielectric layers and internal electrode layers alternately are laminated, and further, dielectric layers are laminated on an upper surface and a lower surface of the multilayer body, and a pair of external electrodes provided on both end surfaces of the multilayer body, and the internal electrode layers each include a counter electrode portion that generates capacitance and an extension electrode portion that extends from the counter electrode portion toward a corresponding one of the external electrodes (for example, Japanese Unexamined Patent Application Publication No. 2001-237137).

In recent years, with the development of electronics technology, in order to reduce the size and increase the capacitance of each multilayer ceramic capacitor, technology has been developed to reduce the thicknesses of dielectric layers and internal electrode layers as much as possible and to increase the number of dielectric layers and internal electrode layers to be laminated.

However, when the dielectric layers and the internal electrode layers are laminated and pressed in the lamination direction at the time of manufacturing, pressure is likely to be applied to the end portion of the internal electrode layer, and damage may occur in the dielectric layer having a reduced thickness in the vicinity thereof. Such damage to the dielectric layer causes a short circuit failure, which easily leads to a decrease in high-temperature reliability. In addition, even when the dielectric layer is not damaged, foreign matter is likely to be blended into the vicinity of the end portion of the internal electrode layer, such that a short circuit failure is likely to occur, and it is difficult to maintain high reliability.

### SUMMARY OF THE INVENTION

Example embodiments of the present invention provides multilayer ceramic capacitors, each with high high-temperature reliability, while achieving a reduction in size and large capacitance.

The inventors of example embodiments of the present invention have discovered that high-temperature reliability is improved by providing a region A having low continuity of the internal electrode layer at the end portion in the width direction of each of the internal electrode layers and making the line coverage of the region A lower than the line coverage of a middle portion in a width direction of the internal electrode layer.

An example embodiment of the present invention provides a multilayer ceramic capacitor which includes a multilayer body including an inner layer portion including a plurality of inner dielectric layers and a plurality of internal electrode layers alternately laminated in a lamination direction, outer layer portions sandwiching the inner layer portion in the lamination direction, two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction, and a pair of external electrodes each on a corresponding one of the two end surfaces and each connected to the plurality of internal electrode layers, in which each of the plurality of internal electrode layers includes an end portion in the width direction including a region A with a low continuity of each of the plurality of internal electrode layers at the end portion, and the region A includes a line coverage lower than that in a middle portion in the width direction of each of the plurality of internal electrode layers.

According to example embodiments of the present invention, it is possible to provide multilayer ceramic capacitors each with high high-temperature reliability by preventing damage to a dielectric layer at an end portion in a width direction of an internal electrode layer and a short circuit due to mixing of foreign matter.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing a multilayer ceramic capacitor according to an example embodiment of the present invention.

FIG. 2 is a cross-sectional view (LT cross-section) taken along the line II-II of the multilayer ceramic capacitor shown in FIG. 1.

FIG. 3 is a cross-sectional view (WT cross-section) taken along the line III-III of the multilayer ceramic capacitor shown in FIG. 1.

FIG. 4 is a schematic view showing a configuration of an inner layer portion of the multilayer ceramic capacitor shown in FIG. 1.

FIG. 5 is an enlarged view of a region V shown in FIG. 3.

### DETAILED DESCRIPTION OF THE EXAMPLE EMBODIMENTS

Hereinafter, example embodiments of the present invention will be described with reference to the drawings, but the present invention is not limited thereto. In addition, the drawings may be schematically simplified and drawn in order to explain the contents of example embodiments of the present invention, and the drawn components or the ratio of the dimensions among the components may not necessarily coincide with the ratio of the dimensions described in the specification. In addition, components described in the specification may be omitted from the drawings, or may be drawn with a reduced number of components.

### Multilayer Ceramic Capacitor

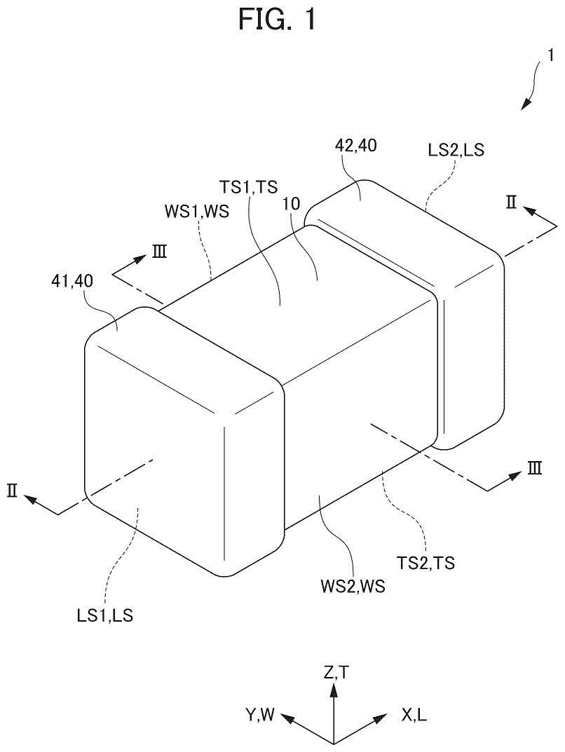

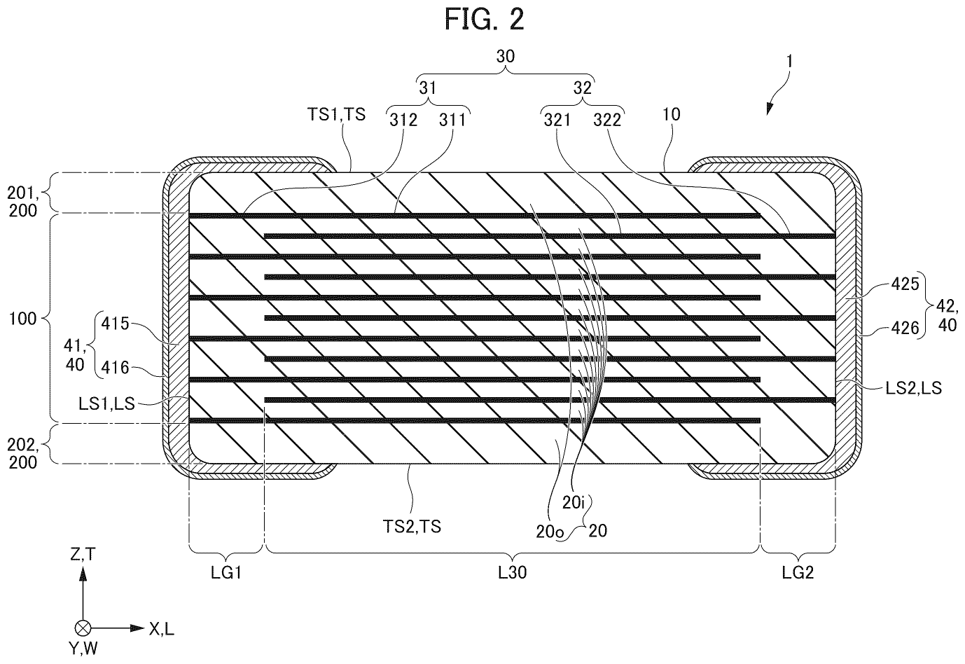

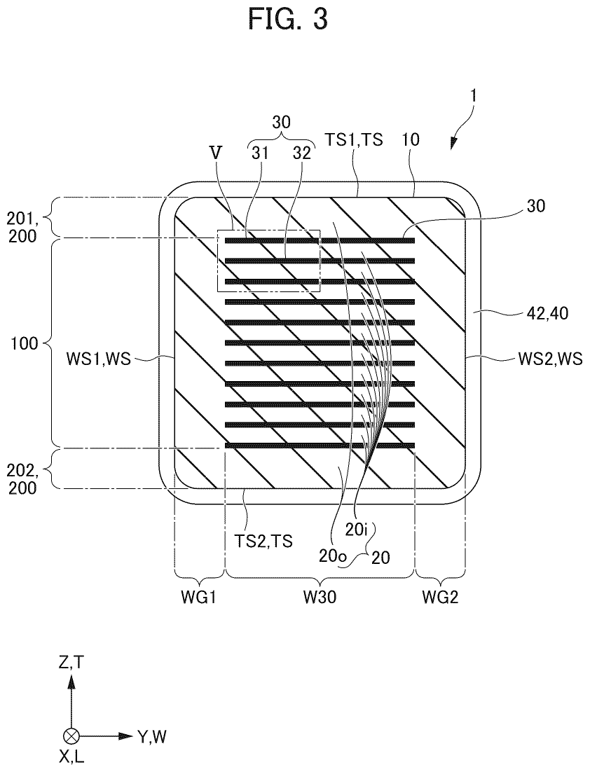

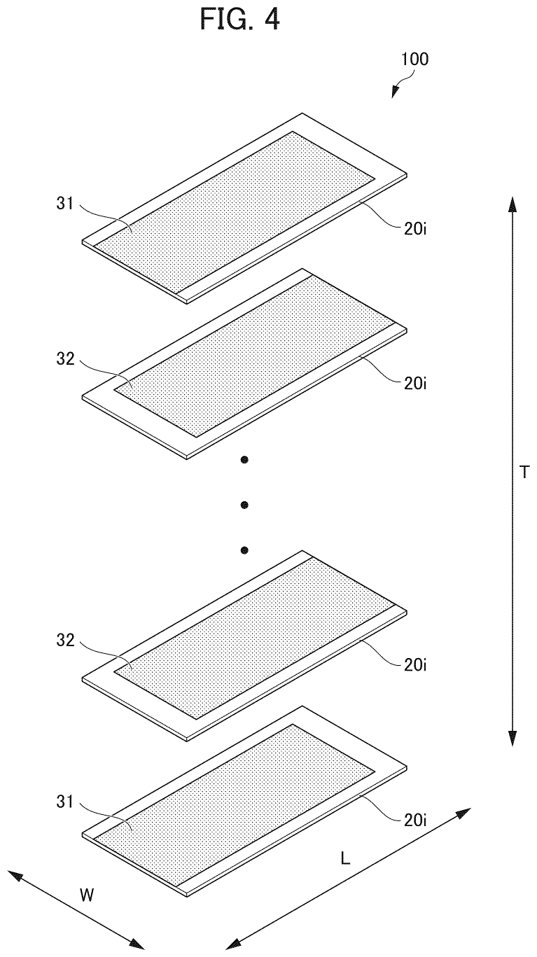

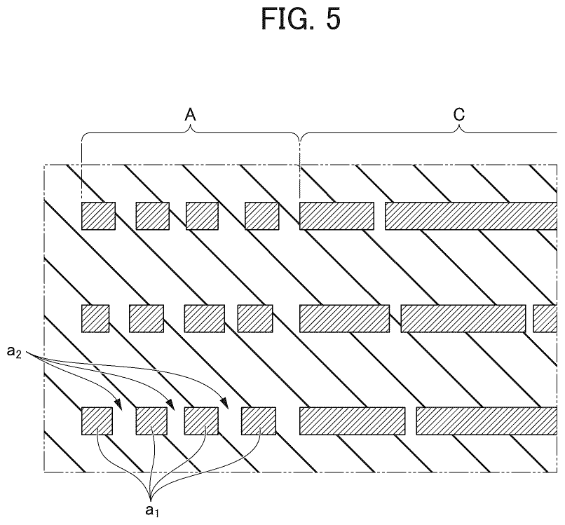

FIG. 1 is a perspective view showing a multilayer ceramic capacitor according to an example embodiment of the present invention. FIG. 2 is a cross-sectional view taken along the line II-II of the multilayer ceramic capacitor shown in FIG. 1. FIG. 3 is a cross-sectional view taken along the line III-III of the multilayer ceramic capacitor shown in FIG. 1. FIG. 4 is a schematic view showing a configuration of an inner layer portion of the multilayer ceramic capacitor shown in FIG. 1. FIG. 5 is an enlarged view of a region V shown in FIG. 3. The multilayer ceramic capacitor 1 shown in FIGS. 1 to 5 includes a multilayer body 10 and external electrodes 40. The external electrodes 40 include a first external electrode 41 and a second external electrode 42.

FIGS. 1 to 3 and 5 show an XYZ orthogonal coordinate system. The X direction refers to a length direction L of the multilayer ceramic capacitor 1 and the multilayer body 10, the Y direction refers to a width direction W of the multilayer ceramic capacitor 1 and the multilayer body 10, and the Z direction refers to a lamination direction T of the multilayer ceramic capacitor 1 and the multilayer body 10. Accordingly, the cross section shown in FIG. 2 is also referred to as an LT cross section, and the cross section shown in FIG. 3 is also referred to as a WT cross section. In addition, the length direction L, the width direction W, and the lamination direction T are not necessarily orthogonal or substantially orthogonal to each other, and may intersect each other.

The size of the multilayer ceramic capacitor is, for example, preferably about 0.2 mm or more and about 10 mm or less in the length direction L, about 0.1 mm or more and about 10 mm or less in the width direction W, and about 0.1 mm or more and about 10 mm or less in the lamination direction T.

### Multilayer Body

The multilayer body 10 has a rectangular or substantially rectangular parallelepiped shape, and includes a first main surface TS1 and a second main surface TS2 opposed to each other in the lamination direction T, a first lateral surface WS1 and a second lateral surface WS2 opposed to each other in the width direction W, and a first end surface LS1 and a second end surface LS2 opposed to each other in the length direction L. The surface of each face may be uneven or rough. In addition, when it is not particularly necessary to distinguish between the first main surface TS1 and the second main surface TS2, they are collectively referred to as a main surface TS, when it is not particularly necessary to distinguish between the first end surface LS1 and the second end surface LS2, they are collectively referred to as an end surface LS, and when it is not particularly necessary to distinguish between the first lateral surface WS1 and the second lateral surface WS2, they are collectively referred to as a side surface WS.

Corner portions and ridge portions of the multilayer body 10 are preferably rounded. Each of the corner portions is a portion where the three surfaces of the multilayer body 10 intersect, and each of the ridge portions is a portion where the two surfaces of the multilayer body 10 intersect.

As shown in FIGS. 2 and 3, the multilayer body 10 includes a plurality of inner dielectric layers 20i and a plurality of internal electrode layers 30 laminated in the lamination direction T. In addition, the multilayer body 10 includes an inner layer portion 100, and a first outer layer portion 201 and a second outer layer portion 202 sandwiching the inner layer portion 100 in the lamination direction T.

The inner dielectric layers 20i defining the inner layer portion 100 and outer dielectric layers 200 defining the outer layer portion 200 may have different component compositions because the inner layer portion 100 and the outer layer portion 200 have different functions. For example, the inner dielectric layers 20i are required to have a high dielectric constant, and the outer dielectric layers 200 are required to have high moisture resistance, weather resistance, and strength. For this reason, the dielectric layer defining the inner layer portion 100 is described as the inner dielectric layers 20i, and the dielectric layer defining the outer layer portion 200 is described as the outer dielectric layers 200. However, when it is not necessary to particularly distinguish between the inner layer dielectric layers 20i and the outer dielectric layers 200, they will be collectively described as the dielectric layer 20.

### Inner Layer Portion

FIG. 4 schematically shows the configuration of the inner layer portion 100. The inner layer portion 100 includes the plurality of inner dielectric layers 201 and the plurality of internal electrode layers 30. In the inner layer portion 100, the plurality of internal electrode layers 30 are opposed to each other with a corresponding one of the inner dielectric layers 201 interposed therebetween. The inner layer portion 100 is a portion that generates capacitance and substantially defines and functions as a capacitor.

As the material of the dielectric layer 20, for example, a dielectric ceramic including BaTiO₃, CaTiO₃, SrTiO₃, CaZrO₃, or the like as a main component can be used. As a material of the dielectric layer 20, for example, a Mn compound, a Fe compound, a Cr compound, a Co compound, a Ni compound, or the like may be added as a subcomponent.

The thickness of each of the inner dielectric layers 20i is not particularly limited, but is preferably, for example, about 0.2 μm or more and about 15 μm or less. The capacitance can be improved by reducing the thickness of each of the inner dielectric layers 20i.

### Outer Layer Portion

The first outer layer portion 201 is provided adjacent to the first main surface TS1 of the multilayer body 10, and the second outer layer portion 202 is provided adjacent to the second main surface TS2 of the multilayer body 10. More specifically, the first outer layer portion 201 is provided between the first main surface TS1 and an internal electrode layer 30 closest to the first main surface TS1 among the plurality of internal electrode layers 30, and the second outer layer portion 202 is provided between the second main surface TS2 and an internal electrode layer 30 closest to the second main surface TS2 among the plurality of internal electrode layers 30. The first outer layer portion 201 and the second outer layer portion 202 do not include any internal electrode layer 30.

The outer layer portion 200 is made of an insulating material. Each of the first outer layer portion 201 and the second outer layer portion 202 may include a plurality of outer layer dielectric layers 200, or may include a single outer layer dielectric layer 200. The outer dielectric layer 200 can be made of the same type of dielectric material as the inner dielectric layer 20i, but may include a different component from the inner dielectric layers 20i depending on the required function.

### Internal Electrode Layer

The plurality of internal electrode layers 30 include a plurality of first internal electrode layers 31 and a plurality of second internal electrode layers 32. The plurality of first internal electrode layers 31 and the plurality of second internal electrode layers 32 are alternately provided in the lamination direction T of the multilayer body 10.

Each of the first internal electrode layers 31 includes a counter electrode portion 311 and an extension electrode portion 312, and each of the second internal electrode layers 32 includes a counter electrode portion 321 and an extension electrode portion 322.

The counter electrode portion 311 and the counter electrode portion 321 are opposed to each other with a corresponding one of the inner dielectric layers 20i interposed therebetween in the lamination direction T of the multilayer body 10. The shapes of the counter electrode portion 311 and the counter electrode portion 321 are not particularly limited, and may be rectangular or substantially rectangular, for example. The counter electrode portions 311 and the counter electrode portions 321 are portions that generate capacitance and substantially define and function as capacitors.

Each of the extension electrode portions 312 extends from the counter electrode portion 311 toward the first end surface LS1 of the multilayer body 10, and is exposed at the first end surface LS1. Each of the extension electrode portions 322 extends from the counter electrode portion 321 toward the second end surface LS2 of the multilayer body 10, and is exposed at the second end surface LS2. The lengths of the counter electrode portion 311 and the extension electrode portion 312 in the width direction W may be the same or different. Further, the lengths of them in the width direction W may gradually change toward the first end surface LS1 at which the extension electrode portions are exposed. The lengths of the counter electrode portion 321 and the extension electrode portion 322 in the width direction W may be the same or different. Further, the lengths of them in the width direction W may gradually change toward the exposed second end surface LS2 at which the extension electrode portions are exposed.

Thus, each of the first internal electrode layers 31 is connected to the first external electrode 41, and a space is provided between each of the first internal electrode layers 31 and the second end surface LS2 of the multilayer body 10, that is, the second external electrode 42. Further, each of the second internal electrode layers 32 is connected to the second external electrode 42, and a space is provided between the second internal electrode layers 32 and the first end surface LS1 of the multilayer body 10, that is, the first external electrode 41.

Each of the first internal electrode layers 31 and the second internal electrode layers 32 mainly include metal Ni. Further, each of the first internal electrode layers 31 and the second internal electrode layers 32 may include, for example, as a main component, at least one of metals such as Cu, Ag, Pd, Sn or Au, or an alloy including at least one of these metals such as an Ag—Pd alloy, or may include a component other than the main component. Further, the first internal electrode layers 31 and the second internal electrode layers 32 may include dielectric particles of the same composition system as the ceramic included in the inner dielectric layers 20i, as a component other than the main component. In the present specification, the metal as the main component refers to a metal component having the highest weight %.

The thicknesses of the first internal electrode layers 31 and the second internal electrode layers 32 are not particularly limited, but are, for example, preferably about 0.2 μm or more and about 2.0 μm or less, and more preferably about 0.30 μm or more and about 0.35 μm or less. The number of the first internal electrode layers 31 and the second internal electrode layers 32 is not particularly limited.

Examples of a method of measuring the thicknesses of the inner dielectric layers 201 and the internal electrode layers 30 include, for example, a method of observing an LT cross section in the vicinity of the middle in the width direction of the multilayer body exposed by polishing with a scanning electron microscope. Each value may be an average value of measured values at a plurality of positions in the length direction, or may be an average value of measured values at a plurality of positions in the lamination direction.

As shown in FIG. 3, the multilayer body 10 includes an electrode counter portion W30 in which the internal electrode layers 30 are opposed to each other in the width direction W, and a first side gap portion WG1 and a second side gap portion WG2 sandwiching the electrode counter portion W30 therebetween. The first side gap portion WG1 is located between the electrode counter portion W30 and the first lateral surface WS1, and the second side gap portion WG2 is located between the electrode counter portion W30 and the second lateral surface WS2. More specifically, the first side gap portion WG1 is located between the end of each of the internal electrode layers 30 adjacent to the first lateral surface WS1 and the first lateral surface WS1, and the second side gap portion WG2 is located between the end of each of the internal electrode layers 30 adjacent to the second lateral surface WS2 and the second lateral surface WS2. The first side gap portion WG1 and the second side gap portion WG2 do not include any internal electrode layer 30, and include only the dielectric layer 20. The first side gap portion WG1 and the second side gap portion WG2 are also referred to as W gaps.

As shown in FIG. 2, the multilayer body 10 includes an electrode counter portion L30 in which the first internal electrode layers 31 and the second internal electrode layers 32 of the internal electrode layer 30 are opposed to each other in the length direction L, a first end gap portion LG1, and a second end gap portion LG2. The first end gap portion LG1 is located between the electrode counter portion L30 and the first end surface LS1, and the second end gap portion LG2 is located between the electrode counter portion L30 and the second end surface LS2. More specifically, the first end gap portion LG1 is located between the end of each of the second internal electrode layers 32 adjacent to the first end surface LS1 and the first end surface LS1, and the second end gap portion LG2 is located between the end of each of the first internal electrode layers 31 adjacent to the second end surface LS2 and the second end surface LS2. The first end gap portion LG1 does not include any second internal electrode layer 32, and includes the first internal electrode layers 31 and the inner dielectric layers 20i, and the second end gap portion LG2 does not include any first internal electrode layer 31, and includes the second internal electrode layers 32 and the inner dielectric layers 201. The first end gap portion LG1 functions as the extension electrode portions of the first internal electrode layers 31 toward the first end surface LS1, and the second end gap portion LG2 functions as the extension electrode portions of the second internal electrode layers 32 toward the second end surface LS2. The first end gap portion LG1 and the second end gap portion LG2 are also referred to as L gaps.

The counter electrode portions 311 of the first internal electrode layers 31 and the counter electrode portions 321 of the second internal electrode layers 32 described above are located in the electrode counter portion L30. Further, the extension electrode portions 312 of the first internal electrode layers 31 are located in the first end gap portion LG1, and the extension electrode portions 322 of the second internal electrode layers 32 are located in the second end gap portion LG2.

Examples of the method of measuring, with a scanning electron microscope, the thickness of the multilayer body 10 include a method of observing the LT cross section in the vicinity of the middle in the width direction of the multilayer body exposed by polishing, or the WT cross section in the vicinity of the middle in the length direction of the multilayer body exposed by polishing. Further, each value may be an average value of a plurality of measured values in the length direction or the width direction. Similarly, examples of a method of measuring the length of the multilayer body 10 include, for example, a method of observing an LT cross section in the vicinity of the middle in the width direction of the multilayer body exposed by polishing with a scanning electron microscope. Each value may be an average value of a plurality of measured values in the lamination direction. Similarly, examples of a method of measuring the width of the multilayer body 10 include, for example, a method of observing a WT cross section in the vicinity of the middle in the length direction of the multilayer body exposed by polishing with a scanning electron microscope. Each value may be an average value of a plurality of measured values in the lamination direction.

### External Electrode

The external electrode 40 includes a first external electrode 41 and a second external electrode 42.

The first external electrode 41 is provided on the first end surface LS1 of the multilayer body 10, and is connected to the first internal electrode layers 31. The first external electrode 41 may extend from the first end surface LS1 toward a portion of the first main surface TS1 and a portion of the second main surface TS2. The first external electrode 41 may extend from the first end surface LS1 toward a portion of the first lateral surface WS1 and a portion of the second lateral surface WS2.

The second external electrode 42 is provided on the second end surface LS2 of the multilayer body 10, and is connected to the second internal electrode layer 32. The second external electrode 42 may extend from the second end surface LS2 toward a portion of the first main surface TS1 and a portion of the second main surface TS2. The second external electrode 42 may extend from the second end surface LS2 toward a portion of the first lateral surface WS1 and a portion of the second lateral surface WS2.

The first external electrode 41 includes a base electrode layer 415 and a plated layer 416, and the second external electrode 42 includes a base electrode layer 425 and a plated layer 426. The first external electrode 41 may include only the plated layer 416, and the second external electrode 42 may include only the plated layer 426.

The base electrode layer 415 and the base electrode layer 425 may be fired layers including metal and glass. Examples of the glass include glass components including at least one of B, Si, Ba, Mg, Al, Li, or the like. As a specific example, borosilicate glass can be used. The metal includes Cu as a main component. The metal may include, as a main component, at least one of metals such as Ni, Ag, Pd or Au, and an alloy such as an Ag—Pd alloy, component other than the main component.

The fired layer is a layer obtained by applying an electrically conductive paste including metal and glass to a multilayer body by a dipping method and firing the paste. The fired layer may be fired after firing the internal electrode layers, or may be fired simultaneously with the firing of the internal electrode layers. The fired layer may include a plurality of layers.

Alternatively, the base electrode layer 415 and the base electrode layer 425 may be, for example, resin layers including electrically conductive particles and a thermosetting resin. The resin layer may be provided on the above-described fired layer, or may be directly provided on the multilayer body without providing the fired layer.

The resin layer is a layer obtained by applying an electrically conductive paste including electrically conductive particles and a thermosetting resin to a multilayer body by a coating method and firing the paste. The resin layer may be fired after firing the internal electrode layers, or may be fired simultaneously with the firing of the internal electrode layers. The resin layer may include a plurality of layers.

The thickness per one layer of each of the base electrode layer 415 and the base electrode layer 425 as the fired layer or the resin layer is not particularly limited, and may be about 2 μm or more and about 220 μm or less, for example.

Alternatively, each of the base electrode layer 415 and the base electrode layer 425 may be formed by a thin film formation method such as, for example, a sputtering method or a vapor deposition method, and may be a thin film layer having a thickness of, for example, about 1 μm or less on which metal particles are deposited.

The plated layer 416 covers at least a portion of the base electrode layer 415, and the plated layer 426 covers at least a portion of the base electrode layer 425. The plated layer 416 and the plated layer 426 include, for example, at least one of metals such as Cu, Ni, Ag, Pd or Au, or an alloy such as an Ag—Pd alloy.

Each of the plated layer 416 and the plated layer 426 may include a plurality of layers. A two-layer configuration of Ni plating and Sn plating is preferable. The Ni plated layer can prevent the base electrode layer from being eroded by the solder when the ceramic electronic component is mounted, and the Sn plated layer can improve the wettability of the solder when the ceramic electronic component is mounted, and thus can be easily mounted. Each of the plated layer 416 and the plated layer 426 may have, for example, a three-layer configuration by laminating Cu plating, Ni plating, and Sn plating. The outermost layer may be Au-plated.

The thickness of each of the plated layer 416 and the plated layer 426 per one layer is not particularly limited, and may be, for example, about 1 μm or more and about 10 μm or less.

### Region A

As shown in FIG. 5, the multilayer ceramic capacitor 1 according to the above-described example embodiment of the present invention includes a region A having low continuity of the internal electrode layer 30 at the end portion in the width direction W of each of the internal electrode layers 30, and the region A has the line coverage lower than the line coverage of the middle portion C in the width direction W of the internal electrode layer 30.

In general, in order to reduce the size and increase the capacitance of the multilayer ceramic capacitor, the thickness of each of the dielectric layers and the thickness of each of the internal electrode layers are reduced as much as possible, and the number of the dielectric layers and the internal electrode layers to be laminated is increased. However, the dielectric layers and the internal electrode layers are laminated and pressed in the lamination direction at the time of manufacturing, the stress by pressing is likely to be applied at the end portions of the internal electrode layers. This may cause damage to the dielectric layers in the vicinity of the end portions of the internal electrode layers. Such damage to the dielectric layer tends to cause a short circuit failure, which leads to a decrease in high-temperature reliability. In addition, even if the dielectric layer is not damaged, since foreign matter is likely to be mixed in the vicinity of the end portion of the internal electrode layer, a short circuit defect is likely to occur, and thus it is difficult to maintain high reliability.

The multilayer ceramic capacitor 1 according to the above-described example embodiment of the present invention includes the region A having low continuity of the internal electrode layer 30 at the end portion in the width direction W of each of the internal electrode layers 30 and makes the line coverage of the region A lower than the line coverage of the middle portion C in the width direction W of the internal electrode layer 30. This makes it possible to reduce or prevent the charge of the electric charge to the internal electrode layer in the region A and to reduce the influence of the electric field on the dielectric layer in the vicinity of the region A. With such a configuration, even when the dielectric layer 20 is damaged or foreign matter is mixed, a short circuit failure will not occur in the internal electrode layer 30, and high reliability can be achieved.

The region A includes internal e existing regions a₁ and internal electrode dividing regions a₂. Each of the internal electrode existing regions a₁ is a region where the internal electrode layer exists, and each of the internal electrode dividing regions a₂ is a region between two internal electrode existing regions a₁ adjacent to each other in the width direction W.

The length of each of the internal electrode dividing regions a₂ is, for example, preferably about 3 μm or less. When the length of each of the internal electrode dividing regions a₂ is larger than about 10 μm, the line coverage in the region A becomes too low, such that the capacitance of the multilayer ceramic capacitor decreases.

The length of the region A in the width direction W is, for example, preferably about 5 μm or more and about 20 μm or less. That is, in the WT cross section, it is preferable that the region A has the shortest length of, for example, about 5 μm and the longest length of about 20 μm from the edge in the width direction W of the internal electrode layer 30. It is preferable that the region A is provided by adjusting the length within this range.

By adjusting the length of the region A in the width direction W within such a range, it is possible to reliably prevent the occurrence of a short circuit or the like caused by damage to the dielectric layer 20 or mixing of foreign matter, and to further maintain high reliability. In addition, when the length of the region A is less than 5 μm, the advantageous effect of the region A cannot be sufficiently obtained. On the other hand, when the length of the region A exceeds about 20 μm, the effective area of the internal electrode layer 30 generating the capacitance of the multilayer ceramic capacitor decreases, and the capacitance of the multilayer ceramic capacitor decreases.

The line coverage of the region A is, for example, preferably about 50% or less, and more preferably about 30% or more and 40% or less. When the line coverage of the region A is larger than about 50%, the advantageous effect of the region A cannot be sufficiently exhibited, and when the dielectric layer 20 is damaged or foreign matter is mixed in the end portion of the internal electrode layer 30 in the width direction W, a short circuit or the like occurs, which makes it difficult to maintain high-temperature reliability. The difference between the line coverage of the region A and the line coverage of the middle portion C is, for example, preferably about 30% or more.

### Line Coverage Measurement

The line coverage is an index indicating continuity of electrically conductive components constituting the internal electrode layer. The line coverage is measured by observing the WT cross section of the multilayer ceramic capacitor in which the internal electrode layers are exposed. In the width direction W of the inner layer portion 100, the two regions of the region A and the middle portion C are defined. In the two regions, the area of the internal electrode layer when the internal electrode layer is assumed to be a sheet having a uniform thickness is compared with the area occupied by the electrically conductive components constituting the actual internal electrode layer, and the ratio of the area occupied by the electrically conductive components constituting the actual internal electrode layer to the area of the internal electrode layer when the internal electrode layer is assumed to be a sheet having a uniform thickness is defined as the line coverage. The average value of the line coverages of the plurality of internal electrode layers measured and calculated for the plurality of internal electrode layers can be used as the line coverage. The magnification of the SEM may be, for example, about 1000 times or more and about 5000 times or less, and is preferably 2000 times. In addition, the measurement conditions such as the acceleration voltage and the magnification are fixed during the measurement.

### Manufacturing of Multilayer Ceramic Capacitor

Next, an example of a method of manufacturing multilayer ceramic capacitor will be described.

First, a ceramic green sheet for forming a dielectric layer and an electrically conductive paste for forming an internal electrode layer are prepared. The electrically conductive paste for forming the internal electrode layer includes a binder and a solvent, and a known organic binder or organic solvent can be used. The electrically conductive paste for forming internal electrodes provides internal electrode layers.

Next, an electrically conductive paste for forming internal electrodes is printed on the ceramic green sheets in a predetermined pattern by, for example, screen printing or gravure printing, thus forming internal electrode patterns. In order to form the region A, the internal electrode pattern is printed so that the thickness of the electrically conductive paste is reduced at a position corresponding to the end portion of the internal electrode layer 30 in the width direction W.

Next, a predetermined number of ceramic green sheets for forming an outer layer on which no internal electrode pattern is formed are laminated, ceramic green sheets on which internal electrodes are formed are sequentially laminated, and a predetermined number of ceramic green sheets for forming an outer layer are laminated thereon, thus manufacturing a multilayer sheet. The ceramic green sheet forms the dielectric layer 20 of the multilayer ceramic capacitor 1.

The obtained multilayer sheet is pressed in the lamination direction by, for example, isostatic pressing or the like to prepare a multilayer block. Next, the multilayer block is cut into a predetermined size, and multilayer chips are cut out. At this time, corner portions and ridge portions of each of the multilayer chips may be rounded by, for example, barrel polishing or the like.

Further, the multilayer chip is fired to produce the multilayer body 10. The firing temperature at this time is, for example, preferably about 900° C. or more and about 1300° C. or less, although it depends on the materials of the dielectric and the internal electrodes.

Next, the electrically conductive paste for forming the base electrode layer 415 is applied to the first end surface LS1 by immersing the first end surface LS1 of the multilayer body 10 in the electrically conductive paste, which is the electrode material for forming the base electrode layer using the dipping method. Similarly, the electrically conductive paste for forming the base electrode layer 425 is applied to the second end surface LS2 by dipping the second end surface LS2 of the multilayer body 10 in the electrically conductive paste, which is the electrode material for forming the base electrode layer using the dipping method. Thereafter, these electrically conductive pastes are fired, so that the base electrode layer 415 and the base electrode layer 425, which are fired layers, are formed. The firing temperature is, for example, preferably about 600° C. or more and about 900° C. or less.

In addition, as described above, the base electrode layer 415 and the base electrode layer 425, which are resin layers, may be formed by, for example, applying an electrically conductive paste including electrically conductive particles and a thermosetting resin by a coating method, and firing the electrically conductive paste, or the base electrode layer 415 and the base electrode layer 425, which are thin films, may be formed by a thin film formation method such as a sputtering method or a vapor deposition method.

Thereafter, the plated layer 416 is formed on the surface of the base electrode layer 415 to form the first external electrode 41, and the plated layer 426 is formed on the surface of the base electrode layer 425 to form the second external electrode 42. Through the above steps, the multilayer ceramic capacitor 1 is obtained.

### EXAMPLES

Various evaluation tests were conducted on the multilayer ceramic capacitors.

### Samples

Dimensions: about 3.15 mm (length direction L)×about 1.65 mm (width direction W)×about 1.65 mm (lamination direction T)
Ceramic Material: BaTiO₃
Capacitance: about 10 μF
Internal Electrode: Ni

### Evaluation of High Temperature Reliability

As an evaluation test for high-temperature reliability, Highly Accelerated Limit Test (HALT) was performed under the following conditions. Conditions: temperature: about 150° C., voltage: about 150 V, about 100 hours.

The evaluation criteria were as follows: ◯ (circle symbol) indicating “pass” when the Log IR value was 10 to the power of 10 or more after the test, A (triangle symbol) indicating “acceptable pass” when the Log IR value was 10 to the power of 9 or more and less than 10 to the power of 10 after the test, and x (cross symbol) indicating “fail” when the Log IR value was less than 10 to the power of 9 after the test.

### Capacitance Evaluation

As an evaluation test of capacitance, measurement was performed using an LCR meter under the following conditions. Conditions: about 1 kHz, about 1 V.

The evaluation criteria were as follows: with the reference value of the capacitance as about 10 μF, values within the range of about ±5% with respect to the reference value were evaluated as ◯ (circle symbol) indicating “pass”, values outside the range of about ±5% and within the range of about ±15% were evaluated as Δ (triangle symbol) indicating “acceptable pass”, and values outside the range of about ±15% were evaluated as x (cross symbol) indicating “fail”.

TABLE 1

| | | Line coverage | | | | | | |
|---|---|---|---|---|---|---|---|---|
| | | of internal | Distance from | | | | | |
| | | electrode | edge portion in | | | | | |
| | | layer in | width direction | | | | | |
| | Line | middle | of internal | | | | | |
| | coverage | portion C | electrode layer | High-temperature | | | | |
| | of | in width | where region | reliability (HALT) | High-temperature | | | |
| | region | direction | A is provided | LogIR value | load reliability | Capacitance | Capacitance | Comprehensive |
| | A(%) | (%) | (μm) | (× 10¹⁰) | evaluation | (μF) | evaluation | evaluation |
| Example 1 | 30.0 | 75.0 | 5 | 23 | ◯ | 9.9 | ◯ | ◯ |
| Example 2 | 35.0 | 71.0 | 10 | 44 | ◯ | 9.7 | ◯ | ◯ |
| Example 3 | 31.0 | 78.0 | 20 | 55 | ◯ | 9.5 | ◯ | ◯ |
| Example 4 | 32.0 | 73.0 | 2 | 0.34 | Δ | 10.1 | ◯ | Δ |
| Example 5 | 39.0 | 78.0 | 42 | 72 | ◯ | 8.5 | Δ | Δ |
| Comparative | 90.0 | 77.0 | — | 0.024 | X | 11.2 | Δ | X |
| Example 1 | | | | | | | | |

As shown in Table 1, it was confirmed that Examples 1 to 5 including the region A including a lower line coverage than the middle portion in the width direction W of the internal electrode layer 30 exhibited favorable results, and among them, Examples 1 to 3 in which the region A was provided in a range of, for example, about 5 μm or more and about 20 μm or less from the edge portion in the width direction W of the internal electrode layer 30 exhibited particularly favorable results in the comprehensive evaluation. In addition, for example, it was confirmed that favorable results were obtained when the line coverage of the region A was about 50% or less. For example, the length of the region A in the width direction W is preferably about 5 μm or more and about 20 μm or less, and the coverage of the region A is preferably about 50% or less. More preferably, for example, the length of the region A in the width direction W is about 5 μm or more and about 20 μm or less, and the coverage of the region A is about 30% or more and about 40% or less. In addition, for example, the length of the region A in the width direction W may be about 5 μm or more and about 20 μm or less, and the coverage of the region A may be lower than the coverage of the middle portion by about 30 percent points or more. With such a configuration, it is possible to achieve high high-temperature reliability while achieving a reduction in size and large capacitance.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of inner dielectric layers and a plurality of internal electrode layers alternately laminated in a lamination direction, outer layer portions sandwiching the inner layer portion in the lamination direction, two main surfaces opposed to each other in the lamination direction, two lateral surfaces opposed to each other in a width direction orthogonal or substantially orthogonal to the lamination direction, and two end surfaces opposed to each other in a length direction orthogonal or substantially orthogonal to the lamination direction and the width direction; and
a pair of external electrodes each on a corresponding one of the two end surfaces and each connected to the plurality of internal electrode layers; wherein
each of the plurality of internal electrode layers includes an end portion in the width direction including a region A with a low continuity of each of the plurality of internal electrode layers at the end portion; and
the region A includes a line coverage lower than that in a middle portion in the width direction of each of the plurality of internal electrode layers.

2. The multilayer ceramic capacitor according to claim 1, wherein the region A has a length in the width direction of about 5 μm or more and about 20 μm or less.

3. The multilayer ceramic capacitor according to claim 1, wherein the line coverage of the region A is about 50% or less.

4. The multilayer ceramic capacitor according to claim 1, wherein the multilayer ceramic capacitor has a dimension in the length direction of about 0.2 mm or more and about 10 mm or less, a dimension in the width direction of about 0.1 mm or more and about 10 mm or less, and a dimension in the lamination direction of about 0.1 mm or more and about 10 mm or less.

5. The multilayer ceramic capacitor according to claim 1, wherein the multilayer body has a rectangular or substantially rectangular parallelepiped shape.

6. The multilayer ceramic capacitor according to claim 1, wherein each of the plurality of inner dielectric layers includes BaTiO₃, CaTiO₃, SrTiO₃, or CaZrO₃ as a main component.

7. The multilayer ceramic capacitor according to claim 6, wherein each of the plurality of inner dielectric layers includes a Mn compound, a Fe compound, a Cr compound, a Co compound, or a Ni compound as a subcomponent.

8. The multilayer ceramic capacitor according to claim 1, wherein a thickness of each of the plurality of inner dielectric layers is about 0.2 μm or more and about 15 μm or less.

9. The multilayer ceramic capacitor according to claim 1, wherein each of the plurality of internal electrode layers mainly includes Ni.

10. The multilayer ceramic capacitor according to claim 1, wherein each of the plurality of internal electrode layers includes Cu, Ag, Pd, Sn or Au, or an alloy including at least one of Cu, Ag, Pd, Sn or Au.

11. The multilayer ceramic capacitor according to claim 1, wherein a thickness of each of the plurality of internal electrode layers is about 0.2 μm or more and about 2.0 μm or less.

12. The multilayer ceramic capacitor according to claim 1, wherein a thickness of each of the plurality of internal electrode layers is about 0.30 μm or more and about 0.35 μm or less.

13. The multilayer ceramic capacitor according to claim 1, wherein each of the pair of external electrodes includes a base electrode layer and a plated layer on the base electrode layer.

14. The multilayer ceramic capacitor according to claim 13, wherein the base electrode layer includes metal and glass.

15. The multilayer ceramic capacitor according to claim 14, wherein the glass includes at least one of B, Si, Ba, Mg, Al, or Li.

16. The multilayer ceramic capacitor according to claim 14, wherein the metal includes Cu as a main component.

17. The multilayer ceramic capacitor according to claim 14, wherein the metal includes at least one of Ni, Ag, Pd or Au, and an alloy including at least one of Ni, Ag, Pd or Au.

18. The multilayer ceramic capacitor according to claim 1, wherein a thickness of each of the pair of external electrodes is about 2 μm or more and about 220 μm or less.

19. The multilayer ceramic capacitor according to claim 13, wherein the plated layer includes a Ni plated layer and a Sn plate layer on the Ni plated layer.

20. The multilayer ceramic capacitor according to claim 13, wherein the plated layer includes a Cu plated layer, a Ni plated layer on the Cu plated layer, and a Sn plated layer on the Ni plated layer.
